(19) United States
(12) Patent Application Publication
(10) Pub. No.: US 2021/0150349 A1
(43) Pub. Date: May 20, 2021

(54) MULTI OBJECT TRACKING USING MEMORY ATTENTION

(71) Applicant: Waymo LLC, Mountain View, CA (US)

(72) Inventors: Wei-Chih Hung, Taipei (TW); Henrik Kretzschmar, Mountain View, CA (US); Yuning Chai, San Mateo, CA (US); Dragomir Anguelov, San Francisco, CA (US)

(21) Appl. No.: 17/099,634

(22) Filed: Nov. 16, 2020

Related U.S. Application Data
(60) Provisional application No. 62/936,332, filed on Nov. 15, 2019.

(51) Int. Cl. G06N 3/08; G06N 3/04; G06N 3/063; G06K 9/62

(52) U.S. Cl. CPC G06N 3/08; G06N 3/04; G06K 2209/21; G06K 9/6232; G06K 9/6215; G06N 3/063

(57) ABSTRACT

Methods, systems, and apparatus, including computer programs encoded on computer storage media, for multi object tracking using memory attention.

### CROSS-REFERENCE TO RELATED APPLICATION

This application claims priority to U.S. Provisional Application No. 62/936,332, filed on Nov. 15, 2019. The disclosure of the prior application is considered part of and is incorporated by reference in the disclosure of this application.

### BACKGROUND

This specification relates to tracking objects in an environment across time.

The environment may be a real-world environment, and the objects may be objects in the vicinity of an autonomous vehicle in the environment.

Autonomous vehicles include self-driving cars, boats, and aircraft. Autonomous vehicles use a variety of on-board sensors and computer systems to detect nearby objects and use such detections to make control and navigation decisions.

Some autonomous vehicles have on-board computer systems that implement neural networks, other types of machine learning models, or both for various prediction tasks, e.g., object classification within images. For example, a neural network can be used to determine that an image captured by an on-board camera is likely to be an image of a nearby car. Neural networks, or for brevity, networks, are machine learning models that employ multiple layers of operations to predict one or more outputs from one or more inputs. Neural networks typically include one or more hidden layers situated between an input layer and an output layer. The output of each layer is used as input to another layer in the network, e.g., the next hidden layer or the output layer.

Each layer of a neural network specifies one or more transformation operations to be performed on input to the layer. Some neural network layers have operations that are referred to as neurons. Each neuron receives one or more inputs and generates an output that is received by another neural network layer. Often, each neuron receives inputs from other neurons, and each neuron provides an output to one or more other neurons.

An architecture of a neural network specifies what layers are included in the network and their properties, as well as how the neurons of each layer of the network are connected. In other words, the architecture specifies which layers provide their output as input to which other layers and how the output is provided.

The transformation operations of each layer are performed by computers having installed software modules that implement the transformation operations. Thus, a layer being described as performing operations means that the computers implementing the transformation operations of the layer perform the operations.

Each layer generates one or more outputs using the current values of a set of parameters for the layer. Training the neural network thus involves continually performing a forward pass on the input, computing gradient values, and updating the current values for the set of parameters for each layer using the computed gradient values, e.g., using gradient descent. Once a neural network is trained, the final set of parameter values can be used to make predictions in a production system.

### SUMMARY

This specification generally describes a system implemented as computer programs on one or more computers in one or more locations that predicts the future trajectory of an object in an environment using vectorized inputs.

The subject matter described in this specification can be implemented in particular embodiments so as to realize one or more of the following advantages.

Robust multi-object tracking (MOT), i.e., detecting and tracking multiple moving objects across time simultaneously, is very important for the safe deployment of self-driving cars. Tracking objects, however, remains a highly challenging problem, especially in cluttered autonomous driving scenes in which objects tend to interact with each other in complex ways and frequently become occluded. This specification describes a system that performs MOT by using attention to compute track embeddings that encode the spatiotemporal dependencies between observed objects. This attention measurement encoding allows the described system to relax hard data associations, which are used by many conventional systems but which may lead to unrecoverable errors. Instead, the system aggregates information from all object detections via soft data associations. The resulting latent space representation allows the model employed by the system to reason about occlusions in a holistic data-driven way and maintain track estimates for objects even when they are occluded. Thus, the described system can perform accurate MOT even in environments where objects frequently become occluded for one or more time steps and then again become visible to the self-driving car.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example system.

FIG. 2 is an illustration of multi-object tracking being performed at a given time step.

FIG. 3 is a flow diagram of an example process for processing new measurements at a given time step.

FIG. 4 is a flow diagram of an example process for determining whether to add new measurements to existing object tracks at the given time step.

Like reference numbers and designations in the various drawings indicate like elements.

### DETAILED DESCRIPTION

This specification describes how a vehicle, e.g., an autonomous or semi-autonomous vehicle, can use an object tracking system to track objects in the vicinity of the vehicle in an environment over time. Tracking objects generally refers to maintaining and updating object tracks across time, with each object track identifying a different object in the vicinity of the environment.

The object tracking data can then be used to make autonomous driving decisions for the vehicle, to display information to operators or passengers of the vehicle, or both. For example, predictions about the future behavior of another object in the environment can be generated based on the object tracking data and can then be used to adjust the planned trajectory, e.g., apply the brakes or change the heading, of the autonomous vehicle to prevent the vehicle from colliding with the other object or to display an alert to the operator of the vehicle.

While this description generally describes object tracking techniques being performed by an on-board system of an autonomous vehicle, more generally, the described techniques can be performed by any system of one or more computers in one or more locations that receives or generates measurements of objects and uses those measurements to track objects across time.

A representation, e.g., a “feature representation” or an “embedded representation,” of a given input as used in this specification, is an ordered collection of numeric values, e.g., a vector or matrix of floating point or other numeric values, that represents characteristics of the given input in a numeric form.

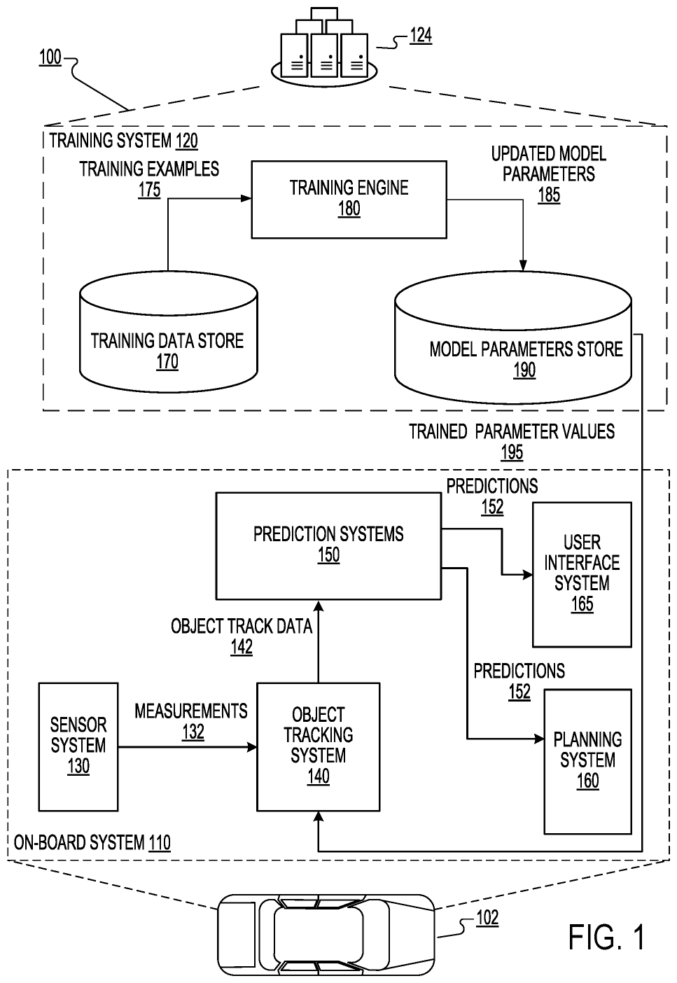

FIG. 1 is a diagram of an example system 100. The system 100 includes an on-board system 110 and a training system 120.

The on-board system 110 is located on-board a vehicle 102. The vehicle 102 in FIG. 1 is illustrated as an automobile, but the on-board system 102 can be located on-board any appropriate vehicle type. The vehicle 102 can be a fully autonomous vehicle that determines and executes fully-autonomous driving decisions in order to navigate through an environment. The vehicle 102 can also be a semi-autonomous vehicle that uses predictions to aid a human driver. For example, the vehicle 102 can autonomously apply the brakes if a prediction indicates that a human driver is about to collide with another vehicle.

The on-board system 110 includes one or more sensor subsystems 130. The sensor subsystems 130 include a combination of components that receive reflections of electromagnetic radiation, e.g., lidar systems that detect reflections of laser light, radar systems that detect reflections of radio waves, and camera systems that detect reflections of visible light.

The sensor data generated by a given sensor generally indicates a distance, a direction, and an intensity of reflected radiation. For example, a sensor can transmit one or more pulses of electromagnetic radiation in a particular direction and can measure the intensity of any reflections as well as the time that the reflection was received. A distance can be computed by determining how long it took between a pulse and its corresponding reflection. The sensor can continually sweep a particular space in angle, azimuth, or both. Sweeping in azimuth, for example, can allow a sensor to detect multiple objects along the same line of sight.

The sensor subsystems 130 or other components of the vehicle 102 can also classify groups of one or more raw sensor measurements from one or more sensors as being measures of an object in the environment, e.g., by applying an object detector to a group of sensor measurements. A group of sensor measurements can be represented in any of a variety of ways, depending on the kinds of sensor measurements that are being captured. For example, each group of raw laser sensor measurements can be represented as a three-dimensional point cloud, with each point having an intensity and a position in a particular two-dimensional or three-dimensional coordinate space. In some implementations, the position is represented as a range and elevation pair. Each group of camera sensor measurements can be represented as an image patch, e.g., an RGB image patch.

Objects that can be measured in the environment include vehicles, motorcyclists, bicyclists, pedestrians, animals, and any other objects in the environment surrounding the vehicle 102.

Once the sensor subsystems 130 classify one or more groups of raw sensor measurements as being measures of an object, the sensor subsystems 130 can compile the raw sensor measurements into a measurement 132 of the object, and send the measurement 132 to an object tracking system 140.

The object tracking system 140, also on-board the vehicle 102, receives the measurements 132 generated by the sensor system 130 and uses the measurements 132 to update object track data 142 maintained by the object tracking system 140. Generally, and as will described in more detail below, the object track data 142 identifies multiple “tracks” of measurements, with each track including measurements that the object tracking system 140 has classified as being measurements of the same object and, therefore, with each of the tracks corresponding to different objects in the environment.

The object tracking system 140 provides the object track data 142 or data derived from the object track data 142 to one or more prediction systems 150, also on-board the vehicle 102.

Each prediction system 150 processes the object track data 142 to generate a respective prediction 152. Examples of predictions that can be generated from the object track data for a given object include a trajectory prediction that predicts the future motion of the given object and an object recognition prediction that predicts the type of the given object, e.g., cyclist, vehicle, or pedestrian.

The on-board system 110 also includes a planning system 160. The planning system 160 can make autonomous or semi-autonomous driving decisions for the vehicle 102, e.g., by generating a planned vehicle path that characterizes a path that the vehicle 102 will take in the future.

The on-board system 100 can provide the predictions 152 generated by the prediction systems 150 to one or more other on-board systems of the vehicle 102, e.g., the planning system 160 and/or a user interface system 165.

When the planning system 160 receives the predictions 152, the planning system 160 can use the predictions 152 to generate planning decisions that plan a future trajectory of the vehicle, i.e., to generate a new planned vehicle path. For example, the predictions 152 may contain a prediction that a particular surrounding object is likely to cut in front of the vehicle 102 at a particular future time point, potentially causing a collision. In this example, the planning system 160 can generate a new planned vehicle path that avoids the potential collision and cause the vehicle 102 to follow the new planned path, e.g., by autonomously controlling the steering of the vehicle, and avoid the potential collision.

When the user interface system 165 receives the predictions 152, the user interface system 165 can use the predictions 152 to present information to the driver of the vehicle 102 to assist the driver in operating the vehicle 102 safely. The user interface system 165 can present information to the driver of the object 102 by any appropriate means, for example, by an audio message transmitted through a speaker system of the vehicle 102 or by alerts displayed on a visual display system in the object (e.g., an LCD display on the dashboard of the vehicle 102). In a particular example, the predictions 152 may contain a prediction that a particular surrounding object is likely to cut in front of the vehicle 102, potentially causing a collision. In this example, the user interface system 165 can present an alert message to the driver of the vehicle 102 with instructions to adjust the trajectory of the vehicle 102 to avoid a collision or notifying the driver of the vehicle 102 that a collision with the particular surrounding object is likely.

To maintain and update the object track data, the object tracking system 140 can use trained parameter values 195, i.e., trained model parameter values of the object tracking system 140, obtained from a trajectory prediction model parameters store 190 in the training system 120.

The training system 120 is typically hosted within a data center 124, which can be a distributed computing system having hundreds or thousands of computers in one or more locations.

The training system 120 includes a training data store 170 that stores the training data used to train the object tracking system 140, i.e., to determine the trained parameter values 195 of the machine learning models employed by the object tracking system 140. The training data store 170 receives raw training examples. For example, the training data store 170 can receive a raw training example 155 from the vehicle 102. The raw training example 155 can be processed by the training system 120 to generate a new training example 175. The new training example 175 can include measurements, i.e., like the measurement 132. The new training example 175 can also include outcome data identifying the ground truth object track assignment for the measurement. The ground truth assignment can be obtained by the training system 120, e.g., from labeled data or from an existing object tracking system.

The training data store 170 provides training examples 175 to a training engine 180, also hosted in the training system 120. The training engine 180 uses the training examples 175 to update model parameters that will be used by the object tracking system 140, and provides the updated model parameters 185 to the trajectory prediction model parameters store 190. Once the parameter values of the object tracking system 140 have been fully trained, the training system 120 can send the trained parameter values 195 to the on-board system 100, e.g., through a wired or wireless connection.

Training the object tracking system 140 is described in more detail below.

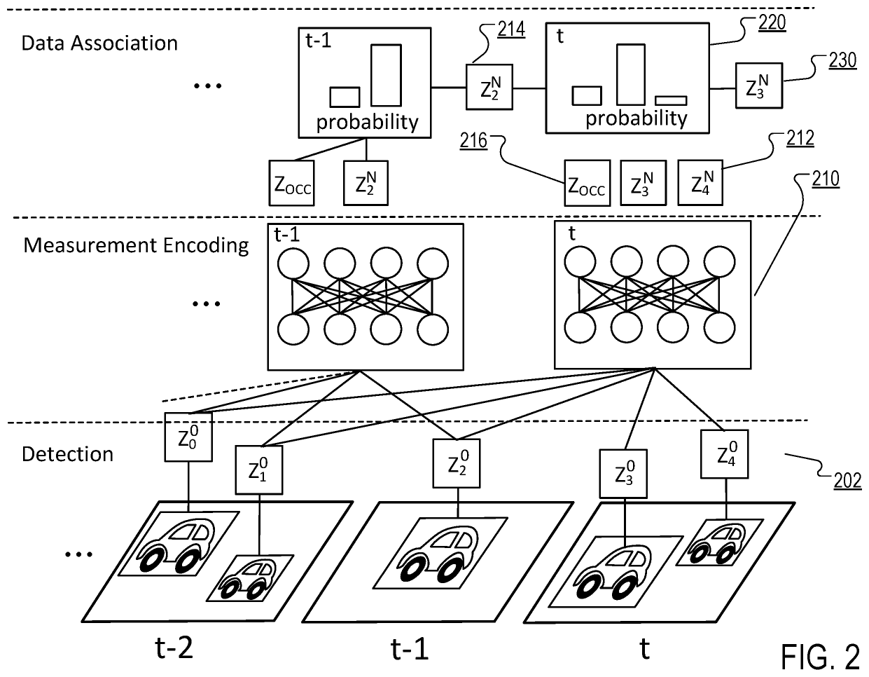

FIG. 2 is an illustration of multi-object tracking being performed at a given time step t.

As shown in FIG. 2, the object tracking system receives two new measurements 202 z3 and z4 at time step t, i.e., that have been generated by performing object detection on sensor data generated at time step t. The object tracking system has also received one earlier measurement z2 at earlier time step t−1 and two earlier measurements z1 and z0 at earlier time step t−2.

At time step t, the system determines whether to associate either of the two new measurements with an object track that is currently identified in object track data maintained by the system.

As will be described in more detail below, the object tracking system maintains object track data that identifies, at any given time, one or more object tracks. Each object track is associated with measurements that the object tracking system has classified as being of the same object. Thus, each object track corresponds to a different object that the object tracking system has determined has appeared in the vicinity of the autonomous vehicle within a recent time window.

At time step t, the object tracking system generates an embedded representation of each new measurement 202 by processing the new measurement 202 using an embedding neural network.

The object tracking system then generates a respective attended feature representation 212 for each of the new measurements 202 by processing (i) the embedded representations of the new measurements 202 and (ii) embedded representations of the measurements received at one or more earlier time steps, i.e., the earlier time steps t−1 and t−2, that precede the current time step t using a self-attention neural network 210 that generates the respective attended feature representations by updating each of the embedded representations by attending over (i) the embedded representations of the new measurements 202 and (ii) the embedded representations of the measurements received at the one or more earlier time steps.

Thus, in the example of FIG. 2, the self-attention neural network 210 aggregates information from object detections received both at the time step t and two earlier time steps t−2 and t−1 to generate the attended feature representations for the new measurements. These attended feature representations therefore represent spatiotemporal dependencies among different objects detected at multiple time steps.

The object tracking system then performs data association for each object track to determine whether to associate any of the new measurements with the object track based on the attended feature representations of the new measurements and a respective feature representation for the object track.

By generating attended feature representations of new measurements by using attention to encode spatiotemporal dependencies between detected objects, both at the time step t and at earlier time steps, the object tracking system can perform the tracking by relaxing hard associations, thereby avoiding unrecoverable errors, and by effectively incorporating the impact of occlusions into the described multi-object tracking scheme.

FIG. 2 shows the data association process for an example one of the object tracks that has a feature representation 214. In particular, the feature representation 214 for the example object track is the attended feature representation generated for the measurement that was most recently associated with the object track, i.e., the attended feature representation for measurement z2 that was added to the example object track at time step t−1.

The object tracking system generates respective similarity scores (represented as probabilities in FIG. 2) between the feature representation 214 and each of the attended feature representations 212 for the new measurements as well as a feature representation for an occluded state 216. The occluded state represents a state of the environment in which the object corresponding to the object track is not measured, i.e., there is no measurement of the object at the current time step because the object is occluded and therefore not able to be detected by the sensors of the vehicle.

The object tracking system then determines to associate 230 the new measurement z3 with the example object track using these similarity scores, i.e., instead of determining that the object corresponding to the object track was occluded and not associating any measurements with the object track or associating the new measurement z4 with the object track.

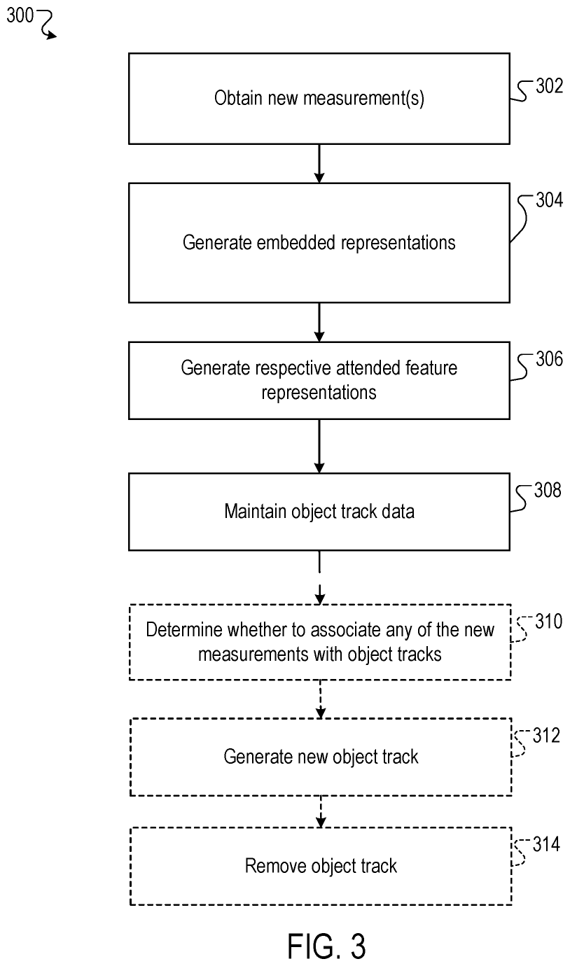

FIG. 3 is a flow diagram of an example process 300 for processing new measurements at a given time step. For convenience, the process 300 will be described as being performed by a system of one or more computers located in one or more locations. For example, an object tracking system, e.g., the object tracking system 140 of FIG. 1, appropriately programmed in accordance with this specification, can perform the process 300.

The system can perform the process 300 at each time step during the operation of the autonomous vehicle in order to repeatedly update the object tracks that are identified in object track data that is maintained by the system.

The system obtains, i.e., receives or generates one or more new measurements at the given time step (step 302). Each new measurement is data characterizing a respective object that has been detected in the environment at the current time step. For example, the new measurements can be generated by applying an object detector to sensor readings of the sensors of the autonomous vehicle at the current time step.

Generally, each new measurement includes data identifying the position of the object in the environment at the current time step and, optionally, data characterizing the appearance of the object. As a particular example, each measurement can include the coordinates of a bounding box in some coordinate system that was identified by the object detector as encompassing the corresponding object and, optionally, an appearance embedding generated by processing a cropped portion of a sensor reading, e.g., point cloud, image, or both, corresponding to the bounding box through a neural network that has been trained to generate embeddings that characterize the embeddings of objects.

For each of the one or more new measurements, the system generates an embedded representation of the new measurement by processing the new measurement using an embedding neural network (step 304). The embedding neural network is a neural network that maps a measurement to an embedded representation, i.e., a feature vector having a fixed dimensionality. For example, the embedding neural network can be a feedforward neural network, e.g., one that has multiple fully-connected neural network layers that are optionally each followed by a layer normalization layer.

The system generates a respective attended feature representation for each of the one or more new measurements by processing (i) the embedded representations of the new measurements and (ii) embedded representations of earlier measurements, i.e., of the measurements that were received at one or more earlier time steps that precede the current time step using a self-attention neural network (step 306).

The earlier measurements can include, for example, each measurement that was received in a fixed size temporal window that ends at the current time step, i.e., each time step that is less than a fixed number of time steps earlier than the current time step.

The embedded representations of the earlier measurements are embedded representations generated by processing the earlier measurements using the embedding neural network.

The self-attention neural network is a neural network that generates the respective attended feature representations for each of the one or more new measurements by updating each of the embedded representations by attending over (i) the embedded representations of the new measurements and (ii) the embedded representations of the measurements received at the one or more earlier time steps.

In particular, the self-attention neural network includes one or more self-attention layers. Each self-attention layer receives as input a respective input feature for each of the measurements and applies a self-attention mechanism to the input features to generate a respective output feature for each of the measurements.

The input features to the first self-attention layer are the embedded representations of the new and earlier measurements and the output features of the last self-attention layer are attended feature representations for the earlier measurements and the new measurements.

To generate output features from input features, each self-attention layer generates, from the input features, a respective query for each measurement by applying a first, learned linear transformation to the input feature for the measurement, a respective key for each measurement by applying a second, learned linear transformation to the input feature for the measurement, and a respective value for each measurement by applying a third, learned linear transformation to the input feature for the measurement. For each particular measurement, the system then generates the output of an attention mechanism for the particular measurement as a linear combination of the values for the measurements, with the weights in the linear combination being determined based on a similarity between the query for the particular measurement and the keys for the measurements. In particular, in some implementations, the operations for the self-attention mechanism for a given self-attention layer can be expressed as follows:

$${z}_{i}^{o} = softmax ( \frac{{q}_{i} {K}^{T}}{\sqrt{{d}_{k}}} ) V ,$$

where zᵢ^{o} is the output of the self-attention layer for a measurement i, qᵢ is the query for the measurement i, K is a matrix of the keys for the measurements, V is a matrix of the values for the measurements, and dₖ is a scaling factor, e.g., equal to the dimensionality of the embedded measurements.

In some cases, the output of the self-attention mechanism is the output features of the self-attention layer. In some other cases, the self-attention layer can perform additional operations on the output of the self-attention mechanism to generate the output features for the layer, e.g., one or more of residual connections, feed-forward layer operations, and layer normalization operations.

In some implementations, each layer of the self-attention neural network applies an attention mechanism that is dependent on a difference in time between the current time step and each of the earlier time steps. In particular, the self-attention operation is by default un-ordered and the system can modify the self-attention mechanism to consider the time step differences between the time step at which each earlier measurement was received and the given time step, i.e., the time step at which the new measurements were received. As a particular example, the system can replace the qᵢK^{T} term in the above equation (which does not take into consideration the time steps of the various measurements) with the following time-dependent term:

qᵢK^{T}+qᵢR^{T}+uK^{T}+vR^{T},

where R is a matrix of learned relative attention features that each depend on the relative position differences between the time step tᵢ of the measurement i and the respective time steps tⱼ of each of the measurements j in the set of new and earlier measurements, and u and v are learned biases. Thus, the system can maintain an additional relative attention feature for each possible value of (tᵢ−tⱼ) and use the relative attention features to modify the attention mechanism to make the attention mechanism dependent on the time difference between various measurements.

When the self-attention neural network includes only one self-attention layer, the system can perform only a portion of the computation of the self-attention layer at inference time because only the attended representations for the new measurements need to be computed. Thus, the system can perform only the operations for the queries corresponding to the new measurements.

As described above, the system maintains object track data that identifies one or more object tracks (step 308). At any given time step, each object track is associated with respective measurements received at one or more earlier time steps that have been classified as characterizing the same object. In other words, each object track corresponds to a different object (as determined by the system) and groups the measurements from earlier time steps that the system has determined are measurements of the corresponding object.

The maintained object track data also includes a respective feature representation for each of the one or more object tracks. As a particular example, the respective feature representation for each of the one or more object tracks can be the attended feature representation generated for the measurement that was most recently associated with the object track. That is, for each object track, the feature representation of the object track is the attended feature representation for the measurement that was added to the object track at the most recent time step (out of all of the measurements that are associated with the object track).

The system determines, for each of the one or more object tracks, whether to associate any of the new measurements with the object track based on the attended feature representations of the new measurements and the respective feature representation for the object track (step 310).

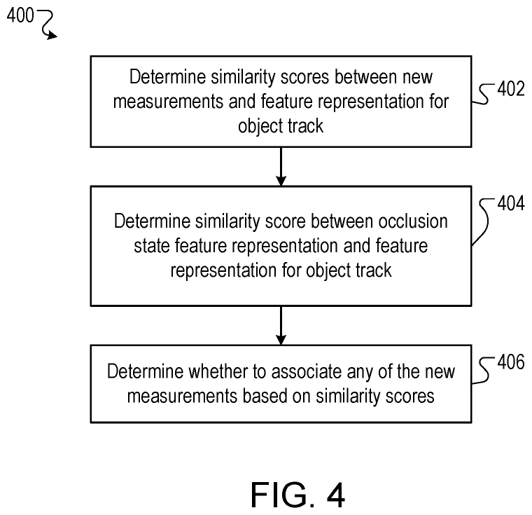

In particular, the system determines, for each of the object tracks, whether to associate a new measurement with the object track or to determine that the object corresponding to the object track is occluded at the given time step and therefore should not be associated with any of the new measurements. One example of making this determination is described below with reference to FIG. 4.

The system also determines, based on the new measurements at the given time step, whether to remove any object tracks from the object track data, i.e., whether to stop tracking any of the currently tracked objects because they are no longer in the vicinity of the vehicle, and whether to add any object tracks to the object track data, i.e., whether a new object has entered the vicinity of the vehicle and therefore needs to be tracked.

As a particular example, in some implementations, can determine whether any of the new measurements have not been associated with any of the object tracks at step 310, and, in response to determining that a particular new measurement is not to be associated with any of the object tracks, the system generates a new object track that identifies only the new measurement and adds the new object track to the object track data (step 312). In some cases, the system designates the new object track as unpromoted and only removes the designation once more than a threshold number, e.g., one, two, or four, additional new measurements are associated with the new object track at subsequent time steps. An unpromoted object track is one that is maintained by the system but for which outputs are not used by other components of the autonomous vehicle, e.g., the planning system, to make driving decisions. That is, the object tracking system would not provide information specifying an unpromoted object track in response to a request for data identifying objects that are currently being tracked by the object tracking system. Maintaining object tracks as unpromoted can prevent the autonomous vehicle from over-reacting to a false positive detection.

As another particular example, in some implementations the system can determine whether any of the object tracks have not been associated with a new measurement for more than a threshold number of consecutive time steps and, if any of the object tracks have not been associated with a new measurement for more than the threshold number of consecutive time steps, removing from the object track data, the data identifying the object track that has not been associated with a new measurement for more than a threshold number of consecutive time steps (step 314).

In some implementations, the system can have different threshold values for unpromoted object tracks than for object tracks that have had the unpromoted designation removed. Generally, in these implementations, the threshold value for unpromoted object tracks can be smaller than for object tracks that have had the unpromoted designation removed, i.e., since unpromoted tracks often have a higher probability of containing false positives.

FIG. 4 is a flow diagram of an example process 400 for determining whether to associate any of the new measurements with a given track at the given time step. For convenience, the process 400 will be described as being performed by a system of one or more computers located in one or more locations. For example, an object tracking system, e.g., the object tracking system 140 of FIG. 1, appropriately programmed in accordance with this specification, can perform the process 400.

For each new measurement, the system determines a respective similarity score between the feature representation for the given object track and the attended feature representation for the new measurement (step 402).

The system determines a similarity score between the feature representation for the given object track and a feature representation for an occlusion state that represents none of the new measurements being associated with the object track (step 404). That is, the occlusion state represents the object corresponding to the object track being occluded at the given time step, i.e., not able to be captured by the sensors of the vehicle at the given time step, either because the object moved out of the range of the sensor or because the object is blocked by another object at the given time step. The system can learn the feature representation for the occlusion state during the training of the models employed by the system. That is, the feature representation for the occlusion state is learned jointly with the training of the embedding neural network and the self-attention neural network.

The system can determine the similarity score between any two feature representations in any of a variety of ways. As a particular example, the system can compute the similarity score by computing the dot product between the two feature representations. Optionally, the system can then normalize the dot products, e.g., by applying a softmax function to the dot products for the attended feature representations and the feature representation for the occluded state, to generate the final similarity scores.

The system determines whether to associate any of the new measurements with the given object track based on the similarity scores for the new measurements and the similarity score for the occlusion state (step 406). In particular, the system determines to either associate none of the new measurements with the given object track, i.e., determines that the corresponding object is occluded at the given time step, or to classify one of the new measurements as being a measurement of the corresponding object.

As a particular example, the system can determine not to associate any of the new measurements with the given object track when the occlusion state is most similar to the feature representation for the object track from among the occlusion state and the new measurements according to the similarity scores, e.g., when the similarity scores indicate that the feature for the occlusion state is more similar to the feature representation than any of the attended feature representations. Similarly, when a particular new measurement is most similar to the feature representation for the object track from among the occlusion state and the new measurements according to the similarity scores, associating the particular new measurement with the object track. Specifically, when higher similarity scores indicate greater similarity, the system can determine not to associate any of the new measurements with the given object track when the occlusion state has the highest similarity score and associate the new measurement having the highest similarity score of any of the new measurements when the occlusion state does not have the highest similarity score.

In some cases, performing the process 400 can result in the same new measurement being selected for being associated with two or more of the object tracks. In these cases, the system can associate the new measurement with only the most similar object track according to the similarity scores between the new measurement and each of the two or more object tracks. In some implementations, the system can refrain from associating any new measurements with any of the two or more object tracks other than the most similar object track at the given time step.

As described above, a training system trains the object tracking system in order to determine trained values of the parameters of the models employed by the object tracking system, i.e., the embedding neural network, the self-attention neural network, and of the occluded state feature representation.

In particular, as described above, the training system trains the object tracking system on training data that includes ground truth assignments for each active object track at any given time step. In other words, the training data identifies, at each given time step and for each active object track as of the given time step, whether a particular new measurement should be added to the object track or the object track should be identified as occluded and no new measurement added.

To perform the training, the training system can train, e.g., using gradient descent with backpropagation, the object tracking system to minimize a loss function using the similarity scores computed for each of the active object tracks at any given time step, i.e., as described above with reference to steps 402 and 404. In particular, the loss function can measure, for each active object track, the negative of the log likelihood, i.e., the negative of the logarithm of the similarity score, assigned by the system to the ground truth assignment for the object track. When the ground truth assignment indicates that no new measurement should be added to an active object track, the ground truth assignment for the active object track is the occluded state. When the ground truth assignment indicates that a particular new measurement should be added to the active object track, the ground truth assignment for the active object track is the particular new measurement.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, off-the-shelf or custom-made parallel processing subsystems, e.g., a GPU or another kind of special-purpose processing subsystem. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain some cases, multitasking and parallel processing may be advantageous.

What is claimed is:

1. A method performed by one or more computers, the method comprising:
receiving, at a current time step, one or more new measurements, each new measurement being data characterizing a respective object that has been detected in an environment at the current time step;
for each of the one or more new measurements, generating an embedded representation of the new measurement by processing the new measurement using an embedding neural network;
generating a respective attended feature representation for each of the one or more new measurements by processing (i) the embedded representations of the new measurements and (ii) embedded representations of measurements received at one or more earlier time steps that precede the current time step using a self-attention neural network that generates the respective attended feature representations by updating each of the embedded representations by attending over (i) the embedded representations of the new measurements and (ii) the embedded representations of the measurements received at the one or more earlier time steps;
maintaining data that identifies one or more object tracks, wherein each object track is associated with respective measurements received at one or more of the earlier time steps that have been classified as characterizing the same object, and wherein the data identifying the one or more object tracks includes a respective feature representation for each of the one or more object tracks; and
determining, for each of the one or more object tracks, whether to associate any of the new measurements with the object track based on the attended feature representations of the new measurements and the respective feature representation for the object track.

2. The method of claim 1, wherein the respective feature representation for each of the one or more object tracks is an attended feature representation generated for the measurement that was most recently associated with the object track.

3. The method of claim 1, wherein the self-attention neural network applies an attention mechanism that is dependent on a difference in time between the current time step and each of the earlier time steps.

4. The method of claim 1, wherein determining, for each of the one or more object tracks, whether to associate any of the new measurements with the object track based on the attended feature representations of the new measurements and the respective feature representation for the object track comprises:
for each new measurement, determining a respective similarity score between the respective feature representation for the object track and the attended feature representation for the new measurement;
determining a similarity score between the respective feature representation for the object track and a feature representation for an occlusion state that represents none of the new measurements being associated with the object track; and
determining whether to associate any of the new measurements with the object track based on the similarity scores for the new measurements and the similarity score for the occlusion state.

5. The method of claim 4, wherein determining whether to associate any of the new measurements with the object track based on the similarity scores for the new measurements and the similarity score for the occlusion state comprises:
when the occlusion state is most similar to the feature representation for the object track from among the occlusion state and the new measurements according to the similarity scores, determining not to associate any of the new measurements with the object track; and
when a particular new measurement is most similar to the feature representation for the object track from among the occlusion state and the new measurements according to the similarity scores, associating the particular new measurement with the object track.

6. The method of claim 1, wherein each new measurement characterizes a position and an appearance of the respective object that has been detected in the environment at the current time step.

7. The method of claim 1, wherein the embedding neural network is a feedforward neural network.

8. The method of claim 1, wherein the one or more earlier time steps are each time step that is less than a fixed number of time steps earlier than the current time step.

9. The method of claim 1, wherein the self-attention neural network comprises a plurality of self-attention layers that are stacked one after the other.

10. The method of claim 1, further comprising:
in response to determining that a particular new measurement is not to be associated with any of the object tracks, generating a new object track that identifies only the new measurement.

11. The method of claim 1, further comprising:
determining that one of the object tracks has not been associated with a new measurement for more than a threshold number of consecutive time steps, and
in response, removing the data identifying the object track that has not been associated with a new measurement for more than a threshold number of consecutive time steps.

12. A system comprising one or more computers and one or more storage devices storing instructions that are operable, when executed by the one or more computers, to cause the one or more computers to perform operations comprising:
receiving, at a current time step, one or more new measurements, each new measurement being data characterizing a respective object that has been detected in an environment at the current time step;
for each of the one or more new measurements, generating an embedded representation of the new measurement by processing the new measurement using an embedding neural network;
generating a respective attended feature representation for each of the one or more new measurements by processing (i) the embedded representations of the new measurements and (ii) embedded representations of measurements received at one or more earlier time steps that precede the current time step using a self-attention neural network that generates the respective attended feature representations by updating each of the embedded representations by attending over (i) the embedded representations of the new measurements and (ii) the embedded representations of the measurements received at the one or more earlier time steps;
maintaining data that identifies one or more object tracks, wherein each object track is associated with respective measurements received at one or more of the earlier time steps that have been classified as characterizing the same object, and wherein the data identifying the one or more object tracks includes a respective feature representation for each of the one or more object tracks; and
determining, for each of the one or more object tracks, whether to associate any of the new measurements with the object track based on the attended feature representations of the new measurements and the respective feature representation for the object track.

13. The system of claim 12, wherein the respective feature representation for each of the one or more object tracks is an attended feature representation generated for the measurement that was most recently associated with the object track.

14. The system of claim 12, wherein the self-attention neural network applies an attention mechanism that is dependent on a difference in time between the current time step and each of the earlier time steps.

15. The system of claim 12, wherein determining, for each of the one or more object tracks, whether to associate any of the new measurements with the object track based on the attended feature representations of the new measurements and the respective feature representation for the object track comprises:
for each new measurement, determining a respective similarity score between the respective feature representation for the object track and the attended feature representation for the new measurement;
determining a similarity score between the respective feature representation for the object track and a feature representation for an occlusion state that represents none of the new measurements being associated with the object track; and
determining whether to associate any of the new measurements with the object track based on the similarity scores for the new measurements and the similarity score for the occlusion state.

16. The system of claim 15, wherein determining whether to associate any of the new measurements with the object track based on the similarity scores for the new measurements and the similarity score for the occlusion state comprises:
when the occlusion state is most similar to the feature representation for the object track from among the occlusion state and the new measurements according to the similarity scores, determining not to associate any of the new measurements with the object track; and
when a particular new measurement is most similar to the feature representation for the object track from among the occlusion state and the new measurements according to the similarity scores, associating the particular new measurement with the object track.

17. The system of claim 12, wherein each new measurement characterizes a position and an appearance of the respective object that has been detected in the environment at the current time step.

18. The system of claim 12, wherein the embedding neural network is a feedforward neural network.

19. The system of claim 12, wherein the one or more earlier time steps are each time step that is less than a fixed number of time steps earlier than the current time step.

20. One or more non-transitory computer-readable storage media encoded with instructions that, when executed by one or more computers, cause the one or more computers to perform operations comprising:
receiving, at a current time step, one or more new measurements, each new measurement being data characterizing a respective object that has been detected in an environment at the current time step;
for each of the one or more new measurements, generating an embedded representation of the new measurement by processing the new measurement using an embedding neural network;
generating a respective attended feature representation for each of the one or more new measurements by processing (i) the embedded representations of the new measurements and (ii) embedded representations of measurements received at one or more earlier time steps that precede the current time step using a self-attention neural network that generates the respective attended feature representations by updating each of the embedded representations by attending over (i) the embedded representations of the new measurements and (ii) the embedded representations of the measurements received at the one or more earlier time steps;
maintaining data that identifies one or more object tracks, wherein each object track is associated with respective measurements received at one or more of the earlier time steps that have been classified as characterizing the same object, and wherein the data identifying the one or more object tracks includes a respective feature representation for each of the one or more object tracks; and
determining, for each of the one or more object tracks, whether to associate any of the new measurements with the object track based on the attended feature representations of the new measurements and the respective feature representation for the object track.
